(19) United States
(12) Patent Application Publication
(10) Pub. No.: US 2009/0039544 A1
(43) Pub. Date: Feb. 12, 2009

(54) AQUEOUS RELEASE AGENT AND ITS USE IN THE PRODUCTION OF POLYURETHANE MOLDING

(75) Inventors: Torsten Henning, Hanau (DE); Peter Alexander, Essen (DE)

Correspondence Address: SCULLY SCOTT MURPHY & PRESSER, PC, 400 GARDEN CITY PLAZA, SUITE 300, GARDEN CITY, NY, 11530, US

(73) Assignee: Evonik Goldschmidt GmbH, Essen (DE)

(21) Appl. No.: 12/177,560

(22) Filed: Jul. 22, 2008

(30) Foreign Application Priority Data
Aug. 9, 2007 (DE) 102007037571.0

(51) Int. Cl. C08K 5/05; C08F 116/00; C08K 5/098; B29C 33/40

(52) U.S. Cl. 264/219; 524/543; 524/379; 524/301

(57) ABSTRACT

The invention relates to aqueous release agent compositions which are characterized in that they comprise, as release-active agent, at least one metal soap and at least one polyalkylene glycol.

### FIELD OF THE INVENTION

The invention relates to aqueous release agents and their use in the production of polyurethane moldings.

### BACKGROUND OF THE INVENTION

It is known that polyurethane systems used for producing moldings exhibit strong adhesion towards the mold materials used, preferably thermally highly conductive materials such as metals. Consequently, during the demolding of polyurethane moldings, release agents are required, which are applied to the mold walls coming into contact with polyurethanes and/or the polyurethane reaction mixture.

Such release agents usually consist of dispersions or emulsions of waxes, soaps, oils and/or silicones in solvents such as hydrocarbons or water.

Following application of the release agent to the mold, the solvent evaporates and the non-volatile release-active substances form a thin release film which is intended to ensure that the polyurethane molding can be easily removed from the mold after production.

In order to reduce the environmental impact with organic material, there is great interest in water-based release agents which are free of volatile organic material. However, compared with classic release agents containing organic solvents, the aqueous release agents on the market have the disadvantage that, after evaporation of a major part of the water, a thin water film always remains in the mold. This water film does not (completely) volatilize at the usual mold temperatures of from 45° to 80° C., preferably 500 to 75° C., and undergoes reactions with the isocyanate compounds of the polyurethane system which lead to very rigid polyurea compounds. This adversely affects the mold surfaces. In particular, the mold surfaces acquire a so-called build-up which has to be removed by complex cleaning.

A typical class of aqueous release agents are soap solutions, i.e., solutions of metal fatty acid salts in water, often with the assistance of alcohols in order to keep the viscosity low and thus to optimize the levelling behavior and the ability to wet mold surfaces. Quite generally, saturated or unsaturated carboxylic acids having 8 to 22 carbon atoms, e.g., in the form of their alkali metal, alkaline earth metal, zinc or aluminium salts, have been found to be useful.

DE 36 00 368 describes solutions of sodium isostearate in water/alcohol mixtures as a release agent optimized with regard to wetting ability. Ethanol, propanol or butanol are specified as preferred alcohols.

The described soap solutions are reintroduced into the mold as a release film before each demolding. In practice, however, the soap solutions exhibit a satisfactory release effect only over a few demoldings. Depending on the type of polyurethane foam, the release effect starts to deteriorate after approximately 20 to 50 demoldings. The release film, which consists primarily of the particular soap following evaporation of a major part of the water, starts to become hard and brittle, and after a certain amount of time release is no longer possible.

In view of the above, there is a need to provide aqueous mold release agents which do not have one or more of the disadvantages of prior art mold release agents and which, preferably, exhibit a good release effect, and they do not leave behind a polyurea build-up on the mold surfaces and/or whose release effect does not deteriorate even upon prolonged repeated application.

### SUMMARY OF THE INVENTION

The present invention provides improved aqueous mold release agents which do not have one or more of the disadvantages of prior art mold release agents. More particularly, the inventive aqueous release agents, preferably, exhibit a good release effect, and they do not leave behind a polyurea build-up on the mold surfaces. Moreover, the inventive aqueous release agents have a release effect that does not deteriorate even upon prolonged repeated application.

Surprisingly, the applicants have found that an aqueous dispersion of classic release-active soaps, e.g., alkali metal, alkaline earth metal, zinc or aluminium salts of saturated or unsaturated carboxylic acids having 8 to 22 carbon atoms in amounts from 0.5 to 40% by weight, preferably 1 to 30% by weight, in combination with polyethers, also referred to as polyalkylene glycols, in amounts from 0.1 to 20% by weight, preferably 0.5 to 10% by weight, based on the aqueous formulation overall achieves the aforementioned properties.

The present invention therefore provides aqueous release agent compositions which comprise, as a release-active agent (e.g., an agent which is able to form a release film on the mold surface), at least one metal soap; and at least one polyalkylene glycol.

Furthermore, the present invention provides the use of a release agent according to the invention for producing polyurethane moldings.

The release agents according to the invention have the advantage that, owing to the polyethers present, the soap release film remains soft even if a major part of the water has vaporized.

### DETAILED DESCRIPTION OF THE INVENTION

The release agents according to the invention and their use are described below by way of example without any intention to restrict the invention to these exemplary embodiments. Where ranges, general formulae or compound classes are given below, then these are intended to include not only the corresponding ranges or groups of compounds that are explicitly mentioned, but also all part ranges and part groups of compounds which can be obtained by removing individual values (ranges) or compounds. If documents are cited in the course of the present description, then their content should in its entirety form part of the disclosure content of the present invention.

As stated above, the present invention provides aqueous release agents and a method of using the same. In particular, the aqueous release agents of the invention include, as a release-active agent (e.g., an agent which is able to form a release film on the mold surface), at least one metal soap; and at least one polyalkylene glycol. Optionally, the aqueous release agents may also include auxiliaries and/or additives.

Release-active metal soaps that may be present in the release agent compositions according to the invention are, for example, alkali metal, alkaline earth metal, zinc or aluminium salts, in particular alkali metal salts of saturated or unsaturated carboxylic acids having 8 to 22 carbon atoms. Preferably, alkali metal salts, even more preferably lithium, sodium and/or potassium salts, of saturated or unsaturated carboxylic acids having 8 to 22 carbon atoms are present in the compositions according to the invention as metal soaps.

The metal soaps present in the release agent compositions according to the invention are preferably salts of carboxylic acids which are based on known monobasic fatty acids, such as, for example, natural vegetable or animal fats or oils having 8 to 22 carbon atoms, in particular having 12 to 18 carbon atoms. Preferably, one or more salts of caproic acid, caprylic acid, capric acid, lauric acid, myristic acid, palmitic acid, palmitoleic acid, isostearic acid, stearic acid, oleic acid, linoleic acid, petroselic acid, elaidic acid, arachic acid, behenic acid, erucic acid, gadoleic acid, rapeseed oil fatty acid, soya oil fatty acid, sunflower oil fatty acid, ricinoleic acid, 12-hydroxystearic acid and/or tall oil fatty acid are present as metal soaps in the release agent compositions according to the invention. In principle, all fatty acids with a similar chain distribution are suitable and can be employed in the invention. Particularly preferred metal soaps are salts of isostearic acid, 12-hydroxystearic acid or oleic acid. Highly preferred release-active metal soaps are alkali metal isostearates, in particular sodium isostearate and/or potassium isostearate.

Preferably, the release-active metal soaps are present in fractions from 0.5 to 40% by weight, preferably 1 to 30% by weight, more preferably 3 to 20% by weight and even more preferably 4 to 10% by weight, based on the total composition.

Polyalkylene glycols that may be present in the release agent compositions according to the invention, include for example those based on ethylene oxide (EO), propylene oxide (PO) or EO and PO ethylene oxide. Preferably, those polyalkylene glycols which are obtainable by polymerization or copolymerization of ethylene oxide (EO) and/or propylene oxide (PO) with a polyhydric alcohol are present. The polyhydric alcohol used may be, for example, ethylene glycol, diethylene glycol, triethylene glycol, tetraethylene glycol, 1,2- or 1,3-propanediol, 1,3- or 1,4-butanediol, 1,6-hexanediol, 1,8-octanediol, dipropylene glycol, polypropylene glycols, dibutylene glycol, polybutylene glycols, glycerol, diglycerol, triglycerol, trimethylolpropane, ditrimethylolpropane, pentaerythritol, dipentaerythritol, quinitol, mannitol sorbitol or methyl glycoside, preferably ethylene glycol, diethylene glycol, triethylene glycol, 1,2- or 1,3-propanediol, dipropylene glycol, glycerol or pentaerythritol.

The polyalkylene glycols present in the release agent compositions according to the invention can have a EO/PO weight ratio from 0:100 to 100:0—It is possible for both pure polypropylene oxides and also pure polyethylene oxides as well as mixed copolymers to be present. The mixed copolymers can have EO/PO units arranged blockwise or randomly.

Preferably, the release agent compositions according to the invention have, as polyalkylene glycol, a polyalkylene glycol with a molar mass from 200 to 30000 g/mol, preferably from 1000 to 20000 g/mol and even more preferably 2000 to 10000 g/mol.

Preferably, the release agent compositions according to the invention comprise, as water-soluble polyalkylene glycol, a commercially available polyalkylene glycol, such as, for example, polyglycol P41/300, polyglycol P41/3000 or polyglycol P41/12000 from Clariant AG.

Preferably, the release agent compositions according to the invention comprise, as polyalkylene glycol, ethylene glycol-diethylene glycol- or triethylene glycol-initiated PO-EO-PG block copolymer, available as Pluronic® RPE 1720 to 3110, BASF.

Preferably, the release agent compositions according to the invention comprise, as polyalkylene glycol, polypropylene oxide, i.e., a polyalkylene glycol which is based exclusively on propylene oxide as alkylene oxide. One such polyalkylene glycol is available, for example, as Acclaim® Polyol 4200 to 18200 from Bayer Material Science LLC.

Since some of the preferred polyalkylene glycols may not be water-soluble, or are only poorly water-soluble, they can preferably be used in the form of an aqueous emulsion in the composition. As emulsifiers, such emulsions can have, for example, the emulsifiers listed below, preferably non-ionic emulsifiers such as ethoxylated fatty alcohols, ethoxylated oxo alcohols and other alcohol ethers. Such emulsifiers are available, for example, under the name Genapol®, Ernulsogen®, manufacturer Clariant AG, or Tego® Alkanol, manufacturer Degussa GmbH/Goldschmidt GmbH. Preferred emulsions have from 30 to 60% by weight of polyalkylene glycol, from 5 to 15% by weight of emulsifier and ad 100% by weight of water.

The release agent composition according to the invention has the polyalkylene glycols preferably in a fraction from 0.1 to 20% by weight, more preferably from 0.5 to 10% by weight and even more preferably from 2 to 5% by weight, based on the aqueous overall formulation.

The release agent compositions according to the invention preferably comprise, or preferably consist of, 0.5 to 40% by weight, more preferably 1 to 30% by weight, even more preferably 3 to 20% by weight and most preferably 5 to 10% by weight, based on the overall composition, of at least one release-active metal soap and 0.1 to 20% by weight, preferably from 0.5 to 10% by weight and even more preferably from 2 to 5% by weight, based on the overall composition, of at least one polyalkylene glycol and optionally auxiliaries and additives and ad 100% by weight water.

One or more compounds selected from the emulsifiers, catalysts, foam stabilizers, viscosity modifiers, preservatives and/or short-chain alcohols having up to 4 carbon atoms may be present as auxiliaries and/or additives in the release agent composition of the invention.

Customary auxiliaries and additives that may be present are one or more compounds selected from the group
I) Emulsifiers:
II) anionic emulsifiers such as alkyl ether carboxylates, alkyl sulphates, fatty alcohol ethoxylate ether sulfates, alpha-olefinsulphonates, alkyl phosphates, alkyl polyether phosphates, alkyl sulphosuceinates; non-ionic emulsifiers, such as ethoxylated fatty alcohols, ethoxylated oxo alcohols and other alcohol ethers, fatty amines, such as dimethylalkylamine, fatty acid alkanolamides, fatty acid esters with alcohols, including glycerol esters or polyglycerol esters or sorbitol esters; cationic emulsifiers, such as acidic-rendered alkyldimethylamines, quaternary nitrogen compounds; finally zwitterionic surfactants. Preference is given to non-ionic emulsifiers. The amount of emulsifiers can be from 0.1 to 10% by weight, preferably 0.5 to 6% by weight, based on the overall composition;
III) Catalysts:
IV) those which are typically used for the polyurethane reaction. For example Lewis acids, such as tin compounds or bismuth compounds, or Lewis bases, such as tertiary amines;

Foam stabilizers: Polysiloxane-polyether copolymers. Such copolymers are described, for example, in Ed. R. Herrington et al., Appendix E Surfactants, Flexible Polyurethane Foams, The Dow Chemical Company, 2nd edition, 1997;

Viscosity modifiers:
I) typical thickeners, such as polyacrylic acid derivatives referred to as carbomers, or other polyelectrolyte thickeners such as water-soluble cellulose derivatives or else xanthan gum. Aliphatic hydrocarbons can also be deemed viscosity modifiers in aqueous formulations, i.e., benzene fractions which swell the waxes used and thus exhibit a thickening effect;
II) customary preservatives, such as bactericides or fungicides, e.g., Euxyl® 100, supplier Schulke & Mayr or Mergal®& K 12, supplier Troy and/or antioxidants, e.g, Irganox® 1520 L, manufacturer Ciba or butylhydroxyanisole;
III) short-chain alcohols having up to 4 carbon atoms, such as, for example, ethanol, n-propanol, isopropanol or butanol.

The fraction of auxiliaries and additives in the overall composition is preferably less than 15% by weight and preferably less than 10% by weight.

The release agent compositions according to the invention can be produced according to the processes known in the prior art or as described below. The soaps can be obtained, for example, from metal hydroxide and fatty acids or fatty acid glycerides. The resulting metal soaps are then diluted with water and then polyalkylene glycols are added directly or in emulsified form, optionally together with the auxiliaries and additives.

The invention farther relates to the use of the release agent compositions according to the invention during the, or for the production of polyurethane moldings.

Classically, the mold is brought to the desired mold temperature from 45° to 80° C., preferably 50° to 75° C., sprayed with release agent, a certain time is allowed to elapse—about 1 to 10 minutes depending on the water content—until the majority of the water has evaporated, and then the reactive polyurethane system comprising polyols, polyisocyanates and optionally further additives such as catalysts, foam stabilizers and propellants, is pumped in. The mold is closed and, after a curing time, is opened and the molding is removed from the mold.

The present invention is described by way of example in the examples listed below without any intention to limit the invention, the scope of application of which arises from the description and the claims in their entirety, to the embodiments specified in the examples.

### EXAMPLES

List of substances used:
Novec™ fluorosurfactant FC-4430=perfluorobutanesulphonate surfactant, manufacturer 3M,
Bayflex® PU 30IS23=polyester polyol, manufacturer: Bayer Material Science AG,
Desmodur® PM 53=isocyanate, manufacturer Bayer Material Science AG,
Pluriol® E 200=polyethylene glycol of average molar mass 200 g/mol, manufacturer BASF,
Polyglycol P 41/3000=polyalkylene glycol, average molar mass 15000, manufacturer Clariant,
Acclaim® 8200=polypropylene oxide of average molar mass 8000 g/mol, manufacturer Bayer AG,
Tego® Acid S100 P═PEG-100 stearate, manufacturer Degussa GmbH.

### Example 1

### Release Agent 1

Composition of release agent 1:4% by weight of potassium isostearate, 3% by weight of ethanol, 2% by weight of Pluriol® E 200, 91% by weight of water.

### Example 2

### Release Agent 2

Composition of release agent 2:8% by weight of sodium isostearate, 4% by weight of ethanol, 2% by weight of polyglycol P 41/3000, 86% by weight of water.

### Example 3

### Release Agent 3

Composition of release agent 3:10% by weight of potassium isostearate, 5% by weight of ethanol, 5% by weight of an emulsion of (35% by weight of Acclaim® 8200, 5% by weight of Tego® Acid S100 P and 60% by weight of water), 80% by weight of water.

### Comparative Example A

### Comparison Release Agent A

Composition of comparison release agent A (according to Example No. 2 from DE 36 00 368): 4.0% by weight of sodium isostearate, 20.8% by weight of ethanol, 5.0% by weight of butanol, 0.2% by weight of Novec™ FC-4430, 70% by weight of water.

### Release Agent Experiments:

The release agents described above were sprayed into test molds using a 0.5 mm nozzle in amounts, simulating those used in practice, of 20 g/m², and said molds were flashed off for a few seconds. Then, a foamable polyurethane system consisting of 100.0 parts (by weight) of Bayflex® PU 30IS23, 10.0 parts of ethylene glycol, 1.0 parts of diethylene glycol, 0.8 part demineralised, 2.0 parts of triethylenediamine (25% by weight in ethylene glycol) and 128.2 parts of Desmodur® PM 53, was foamed into these molds at 50° C. After curing (5 minutes), the moldings were removed from the molds. The procedure was repeated as in Table 1.

TABLE 1
Results of the release experiments:

| | Number of possible release operations until breakdown |
|---|---|
| | of the release effect as a result of excessively inelastic, |
| Release agent | brittle release film |
| 1 | 51 |
| 2 | 72 |
| 3 | >200 |
| A | 18 |

As can be seen from Table 1, considerably more release operations can be carried out with the release agent compositions according to the invention than with the comparison release agent.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. An aqueous release agent composition comprising, as a release-active agent, at least one metal soap; and at least one polyalkylene glycol.

2. The release agent composition of claim 1 further including at least one auxiliary and additive.

3. The release agent composition of claim 1 wherein said at least one metal soap is present in an amount from 0.5 to 40% by weight, said at least one polyalkylene glycol is present in an amount from 0.1 to 20% by weight, and further comprising auxiliaries and additives, and ad 100% by weight water.

4. The release agent composition of claim 2 wherein the at least one auxiliary and additive includes one or more compounds selected from emulsifiers, catalysts, foam stabilizers, viscosity modifiers, preservatives and/or short-chain alcohols having up to 4 carbon atoms.

5. The release agent composition of claim 1 wherein said at least one metal soap comprises an alkali metal isostearate.

6. The release agent composition of claim 1 wherein said at least one polyalkylene glycol has a molar mass from 200 to 30 000 g/mol.

7. The release agent composition according to claim 1 wherein said at least one polyalkylene glycol is polypropylene oxide.

8. A method of preparing a polyurethane mold comprising:
heating a mold to a temperature from 45° to 80° C.;
applying an aqueous release composition to surfaces of said mold, said aqueous release agent composition comprising, as a release-active agent, at least one metal soap, and at least one polyalkylene glycol;
providing a reactive polyurethane system to said mold;
closing said mold; and
curing said reactive polyurethane system to provide a polyurethane molding.

9. The method of claim 8 wherein said aqueous release agent further includes at least one auxiliary and additive.

10. The method of claim 9 wherein said at least one metal soap is present in an amount from 0.5 to 40% by weight, said at least one polyalkylene glycol is present in an amount from 0.1 to 20% by weight, and further comprising auxiliaries and additives, and ad 100% by weight water.

11. The method of claim 9 wherein the at least one auxiliary and additive includes one or more compounds selected from emulsifiers, catalysts, foam stabilizers, viscosity modifiers, preservatives and/or short-chain alcohols having up to 4 carbon atoms.

12. The method of claim 8 wherein said at least one metal soap comprises an alkali metal isostearate.

13. The method of claim 8 wherein said at least one polyalkylene glycol has a molar mass from 200 to 30000 g/mol.

14. The method of claim 8 wherein said at least one polyalkylene glycol is polypropylene oxide.

15. The method of claim 8 wherein said reactive polyurethane system comprises a polyol, a polyisocyanate and optionally at least one additive.
